(19) United States
(12) Patent Application Publication
(10) Pub. No.: US 2014/0137699 A1
(43) Pub. Date: May 22, 2014

(54) TELESCOPIC HANDLE BARS

(71) Applicant: Arne Todd Hutto, Edgewater, FL (US)

(72) Inventor: Arne Todd Hutto, Edgewater, FL (US)

(21) Appl. No.: 14/076,953

(22) Filed: Nov. 11, 2013

Related U.S. Application Data
(60) Provisional application No. 61/727,641, filed on Nov. 16, 2012.

(51) Int. Cl. B62K 21/16

(52) U.S. Cl. CPC B62K 21/16
USPC 74/551.4

(57) ABSTRACT

Handle bars that may extend in length are provided. The handle bars may include an upper handle bar portion and a lower handle bar portion. At least one of the upper handle bar portion and the lower handle bar portion may include a housing and a tube that fits within the housing. The upper handle bar portion may be expanded linearly relative to the lower handle bar portion and therefore may increase the length of the handle bars.

### CROSS-REFERENCE TO RELATED APPLICATION

This application claims the benefit of priority of U.S. provisional application No. 61/727,461, filed Nov. 16, 2012, the contents of which are herein incorporated by reference.

### BACKGROUND OF THE INVENTION

The present invention relates to handle bars and, more particularly, to telescoping handle bars.

Currently, handle bars on motorcycles are not telescopic and interchangeable. Instead, the handle bars are one solid piece. However, it may be desirable to adjust the handle bars for comfort or for style purposes.

As can be seen, there is a need for an a telescopic and interchangeable handle bar.

### SUMMARY OF THE INVENTION

In one aspect of the present invention, an adjustable handle bar comprises: an upper handle bar portion; a lower handle bar portion, wherein at least one of the upper handle bar portion and the lower handle bar portion comprises a housing, and wherein at least one of the upper handle bar portion and the lower handle portion comprises a tube that fits within the housing, wherein the adjustable handle bar is in a compressed form and an expanded form, wherein the expanded form comprises a length of the adjustable handle bar greater than the length of the adjustable handle bar in the compressed form.

These and other features, aspects and advantages of the present invention will become better understood with reference to the following drawings, description and claims.

### BRIEF DESCRIPTION OF THE DRAWINGS

FIG. 1 is a perspective/schematic view of the present invention shown in a compressed configuration.

FIG. 2 is a section detail view of the present invention along line 2-2 in FIG. 1;

FIG. 3 is a perspective/schematic view of the present invention shown in expanded configuration;

FIG. 4 is a section detail view of the present invention along 4-4 in FIG. 3;

FIG. 5 is a perspective view of an alternate embodiment of the present invention:

FIG. 6 is a top view of an alternate embodiment of the present invention;

FIG. 7 is an exploded view of an alternate embodiment of the present invention; and

FIG. 8 is a section view of an alternate embodiment of the present invention along line 8-8 in FIG. 5.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides handle bars that may extend in length. The handle bars may include an upper handle bar portion and a lower handle bar portion. At least one of the upper handle bar portion and the lower handle bar portion may include a housing and a tube that fits within the housing. The upper handle bar portion may be expanded linearly relative to the lower handle bar portion and therefore may increase the length of the handle bars.

The present invention provides a device for telescoping the handle bars of a bicycle, moped, motorcycle, and the like. The shape of the handle bars may include, but is not limited to, round, triangular, oval, blade, square shaped or any shape desired. The handle bar style may include, but is not limited to, a bent corner, Z-bar, narrow bottom, straight, concaved, convex or any combination thereof. By telescoping the handle bars either up or down, the handle bar height may be adjusted. In certain embodiments, there may be a gauging system in which a user may adjust the handle bars to a plurality of different levels. In such embodiments, the user may view and adjust the height of the telescoped handle bars from lowest to highest height.

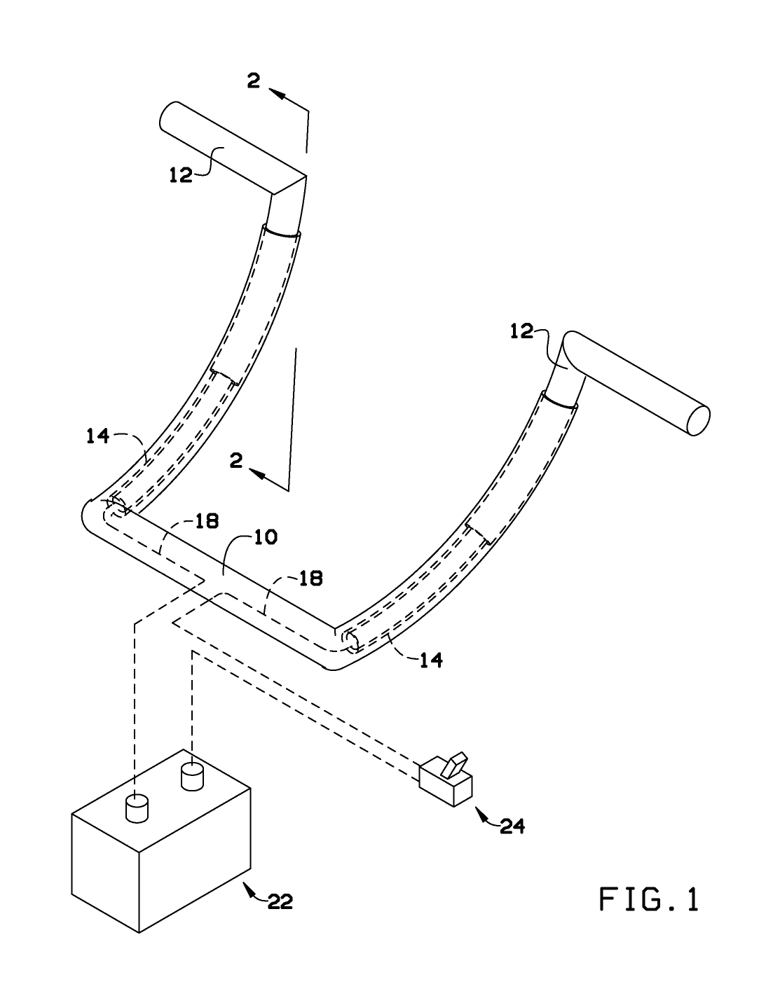

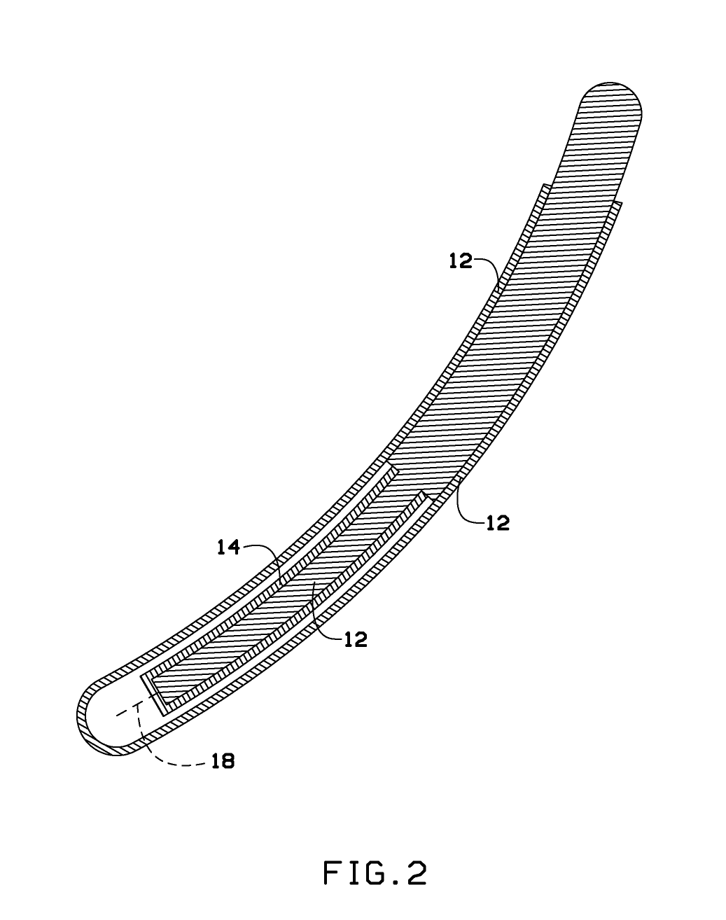

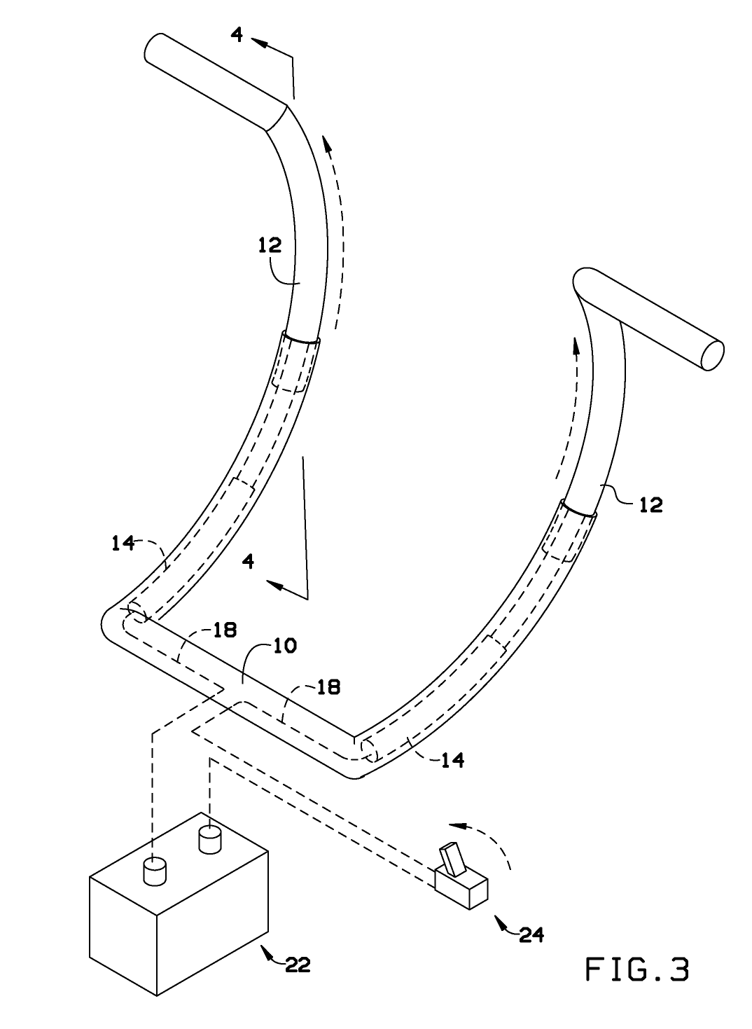

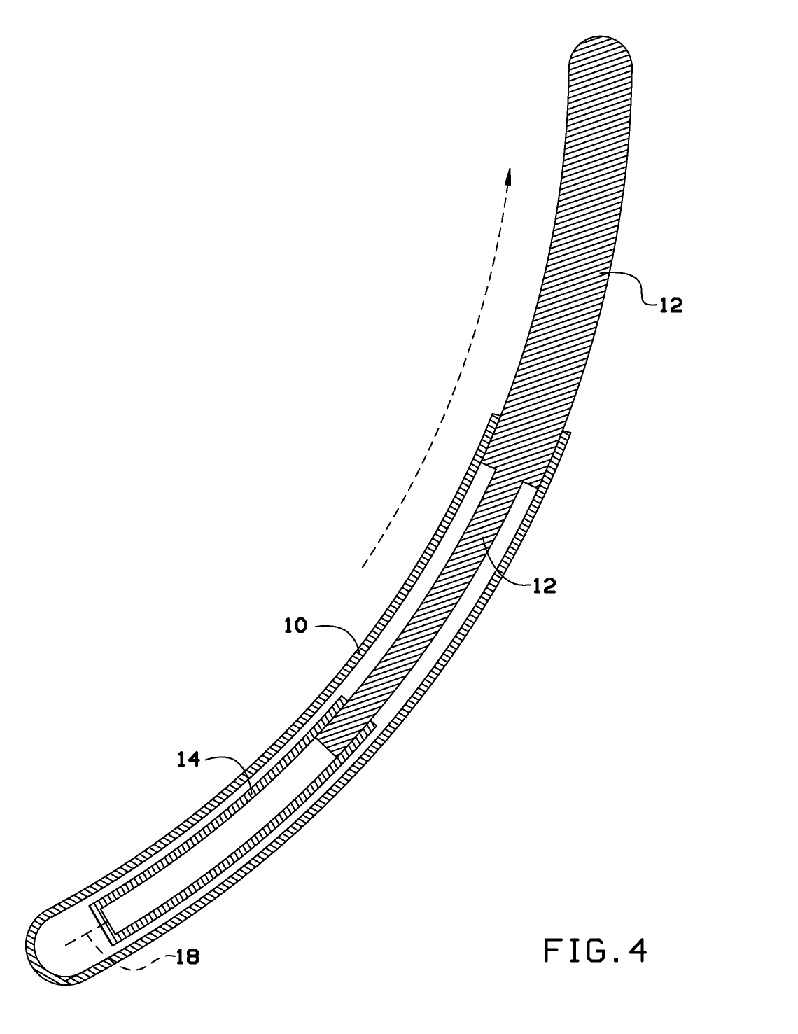

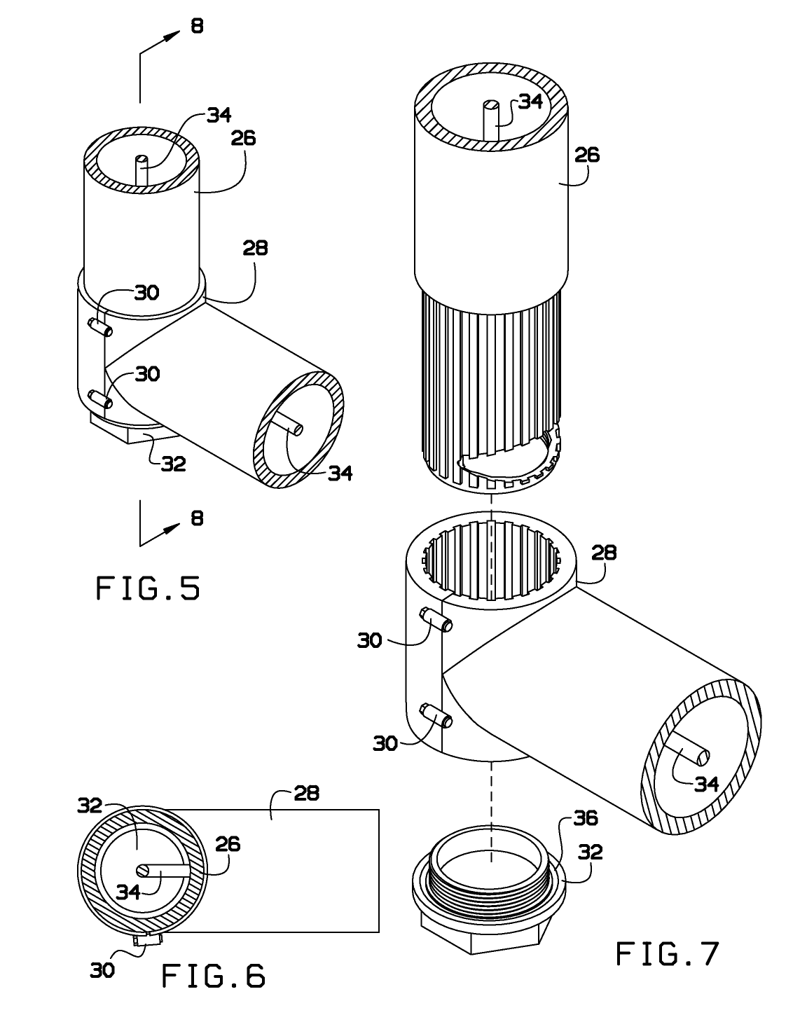

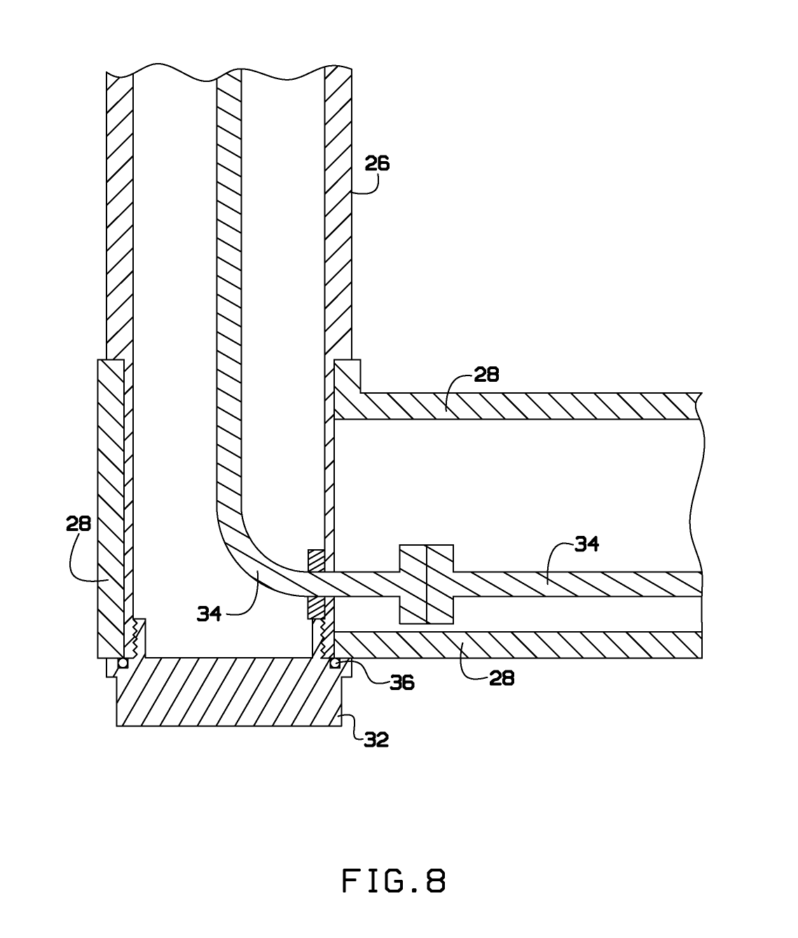

Referring to FIGS. 1 through 8, the present invention may include an adjustable handle bar, The adjustable handle bar may include an upper handle bar portion 12 and a lower handle bar portion 10. At least one of the upper handle bar portion 12 and the lower handle bar portion 10 may include a housing and a tube that fits within the housing. For example, the lower handle bar portion 10 may include the housing and the upper handle bar portion 12 may include the tube that fits within the housing.

The upper handle bar portion 12 and the lower handle bar portion 10 may extend in length, i.e. the upper handle bar portion 12 may be pushed upward to extend the length of the adjustable handle bar. Alternatively, when the upper handle bar portion 12 is in the extended configuration, the upper handle bar portion 12 may be adjusted to compress and shorten the length of the adjustable handle bar.

In certain embodiments, the present invention may include non-powered telescopic handle bar. For example, the handle bars may be raised and lowered using a notch configuration. The upper handle bar portion 12 may include a notch that is spring activated that may be pushed inward. The lower handle bar portion 10 may include an assortment of openings located on different levels. The notch of the upper handle bar portion 12 may fit into the assortment of openings and thereby the height of the handle bars may be adjusted and locked into position. In other embodiments, the upper handle bar portion 12 may be adjusted upwards and downwards with regard to the lower handle bar portion 10 and may be secured to the lower handle bar via a cam lock system. In other embodiments, a clasp system, and a sliding and locking system with a safety lock may be used to secure the handle bars in a raised or lowered position. As can be seen, the telescoping handle bars may include many different configurations.

In certain embodiments, the present invention may include a powered telescopic handle bar. For example, the present invention may utilize a linear actuator 14. The linear actuator 14 may be any linear actuator, such as an electrical linear actuator 14. As illustrated in the Figures, the linear actuator 14 may be connected to a battery 22 via wiring 18, which in turn may be connected to a switch 24. Therefore, a user may activate the switch 24 to activate the linear actuator 14 and extend the handle bars. Alternatively, the switch 24 may be activated to compress the handle bars. The linear actuator 14 may also be an air shock, a hydraulic actuator or the like.

In certain embodiments, the linear actuator 14 may be located within the housing of the lower handle bar portion 10, connecting the bottom of the lower handle bar portion 10 to the bottom of the tube of the upper handle bar portion 12. In certain embodiments, when the air shocks are used, the air shocks may fill up with air and expand. The air shocks may be charged by a compressor. The expanding air shocks may press up against the bottom of the upper handle bar portion 12, and thereby may push the upper handle bar portion 12 into the expanded form. By increasing or decreasing the air in the shocks inside the lower handle bar portion 10, the upper handle bar portion 12 raise or lower the overall height of the handle bars.

In certain embodiments, the lower handle bar portion 10 may include a base and the housing which extends substantially perpendicular from the base. The lower handle bar portion 10 may include multiple components that connect with one another. The base may include a splined interior pipe 28 having opening perpendicular to the base. The multiple components may further include a splined pipe 26 which makes up the housing of the present invention. The splined pipe 26 may be releasably attachable to the splined interior pipe 28 by a threaded cap 32, a split pinch bolt 30, and an O-ring 36. A wiring harness 34 may run through the splined pipe 26, the splined interior pipe 28 and the base to ensure that the pieces are held together.

A method of making the device may comprise the following. The linear actuators may be attached to the lower and upper handle bars. The lower handle bars may be in a tube configuration and the upper handle bars may fit within the tube configuration. In certain embodiments, the upper handle bars may include stops built in to restrict the extension. The lower handle bars may be connected with a crossbar, making the lower handle bars one piece. The wiring connects the battery to the actuator. In addition, the grip portions of the upper handle bars may be attached when the grips are not bent to shape.

It should be understood, of course, that the foregoing relates to exemplary embodiments of the invention and that modifications may be made without departing from the spirit and scope of the invention as set forth in the following claims.

What is claimed is:

1. An adjustable handle bar comprising:
an upper handle bar portion; and
a lower handle bar portion, wherein at least one of the upper handle bar portion and the lower handle bar portion comprise a housing, and wherein at least one of the upper handle bar portion and the lower handle portion comprise a tube that fits within the housing,
wherein the adjustable handle bar is in a compressed form and an expanded form, wherein the expanded form comprises a length of the adjustable handle bar greater than the length of the adjustable handle bar in the compressed form.

2. The adjustable handle bar of claim 1, further comprising a linear actuator connecting the housing and the tube, wherein the linear actuator adjusts the adjustable handle bar from the compressed form to the expanded form and from the expanded form to the compressed form.

3. The adjustable handle bar of claim 2, wherein the upper handle bar portion comprises the tube and the lower handle bar portion comprises the housing.

4. The adjustable handle bar of claim 3, wherein the linear actuator comprises an electric motor connected to a battery and activated by a switch.

5. The adjustable handle bar of claim 4, wherein the linear actuator is located within the housing and below the upper handle bar portion.

6. The adjustable handle bar of claim 1, wherein the linear actuator is at least one air shock.

7. The adjustable handle bar of claim 1, wherein the lower handle bar portion comprises a base and the housing extending perpendicular to the base.

8. The adjustable handle bar of claim 7, wherein the lower handle bar portion comprises multiple components comprising:
the base comprising a splined interior pipe, wherein an opening through the splined interior pipe is perpendicular to the base;
a splined pipe comprising the housing, wherein the splined pipe is releasably attachable to the splined interior pipe; and
a threaded cap configured to secure the splined interior pipe and the splined pipe together.

9. The adjustable handle bar of claim 8, wherein a wiring harness runs through the splined pipe, the splined interior pipe, and the base.
